(19) United States
(12) Patent Application Publication
(10) Pub. No.: US 2010/0062129 A1
(43) Pub. Date: Mar. 11, 2010

(54) LEGUME SHELLER AND METHOD OF USE THEREOF

(76) Inventors: George Taylor, Norman Park, GA (US); Brett A. Taylor, Moultrie, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/205,094

(22) Filed: Sep. 5, 2008

(51) Int. Cl. A23L 1/212; A23N 15/10

(52) U.S. Cl. 426/482; 99/568; 99/580

(57) ABSTRACT

A legume sheller having both an air separator and a sieve separator for removal of residual chaff or trash. Airflow through a screen carries legumes and trash upward, wherein most of the lighter trash is carried farther up the separator and over into a trash retainer. The legumes, and some residual larger pieces of trash, fall over a weir onto a sieve. The sieve has holes therein that permit the legumes to pass through into a collector. Slidable plates adjust the hole dimension. A vibrating table facilitates movement across the downward sloping sieve surface. Baffles prevent the legumes from rolling too quickly across the sieve. The sheller is equipped with a reversing conveyor that carries trash to a bag.

### CROSS-REFERENCE TO RELATED APPLICATIONS

Application Ser. No. 11/156,189, filed Jun. 17, 2005 by George Taylor, entitled “Sheller and Method of Use Thereof”, published on Jan. 4, 2007 as US 2007-0004480 A1, is incorporated herein in its entirety by reference.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to shelling apparatuses for removal of legume coverings, and more specifically to a legume sheller comprising an apparatus for separation of shells and/or pods removed from leguminous vegetables.

2. Description of Related Art

Plants of the pea family, legumes, have their peas or beans within a protective shell. Unfortunately, while the peas or beans provide a desirable food source, the shell is not preferred for human consumption. Accordingly, processing of legumes has principally focused on optimizing the efficiency of removal and separation of the pea or bean from its shell.

Various machines have been devised for removal of the shell from the pea or bean. Principal among these are beating devices that comprise rotating beaters that impact the legume in its shell, breaking the shell and causing same to separate from the pea or bean. Beating the legume can cause damage to the pea or bean if not adequately controlled via a well-designed apparatus. Also, allowing the legumes to transit a sheller too quickly will result in many peas or beans being retained in their shells, thereby reducing product yield. Applicant's above-referenced patent application provides a baffled chamber to increase the dwell time of legumes as they transit through a sheller to optimize the yield of legumes separated from their shells.

Once the pea or bean is separated from its shell, the resulting shell comprises contaminating chaff or trash that must be separated from the desired food product. Often, the beaters are contained in a rotating drum having an exterior that permits passage of the pea or bean, while retaining the trash inside. However, in order to maximize yield, even the best sheller designs permit some trash to pass out of the drum with the pea or bean. Such requires either further processing such as an additional shelling run to separate the pea or bean from the trash, or results in a product contaminated with excess trash.

Therefore, it is readily apparent that there is a need for a legume sheller that provides enhanced separation of legumes from their chaff to produce a high yield of product from each shelling run.

### BRIEF SUMMARY OF THE INVENTION

Briefly described, in a preferred embodiment, the present invention overcomes the above-mentioned disadvantages and meets the recognized need for such a apparatus by providing a legume sheller having a typical drum and beater configuration that dispenses legumes with residual trash onto a conveyor. The conveyor carries the legumes to a separator comprising airflow through a mesh screen over which the legumes and/or trash pass. The airflow through the screen carries legumes and trash upward, wherein the most of the lighter trash is carried farther up the separator and over into a trash retainer. The legumes, and some heavier and larger residual pieces of trash, do not progress far up the separator, instead falling over a weir and subsequently onto a sieve. The sieve has holes therein that permit the legumes to fall through into a collector for subsequent use. The holes are sized for a particular legume and the sieve size is adjustable by movement of two parallel plates with holes therein. Sliding the plates adjusts the hole dimension, wherein only a portion of the holes in each plate are open, while the remaining portion is blocked.

The sieve is on a vibrating table that facilitates movement of legumes and trash across the downward sloping sieve surface. Baffles on the sieve surface prevent the legumes from rolling too quickly across the sieve, thereby providing adequate time for most legumes to fall through a hole into the collector. By the time the trash passes across the surface of the sieve, substantially all legumes have fallen through the holes, while larger trash components do not.

In order to clean the legume sheller, the apparatus is also equipped with a reversing conveyor. When cleaning is desired, the conveyor is moved in reverse and the drum is rotated without its door panels to permit any residual trash to fall onto the conveyor. The trash is carried to a trash bag retained by a bag holder at the inlet end of the legume sheller.

Thus, the instant legume sheller provides two stages of separation, thereby increasing the yield of legumes by removing residual contaminating trash via both air and sieve separation, in addition to the typical-utilized drum separation.

According to its major aspects and broadly stated, the present invention in its preferred form is a legume sheller comprising an air separator and a sieve, wherein the sieve comprises two plates with apertures therein. The two plates are disposed against one another and are slidable to adjust the throughholes formed by the apertures. The sieve further has staggered baffles and may optionally include a vibration table. The air separator has a weir plate disposed at a selected angle within the air separator, the plate being slightly off-parallel to the walls of the air separator. Airflow is parallel to the walls of the air separator and generally parallel to the weir plate. The legume sheller further comprises a conveyor that is operated in reverse to clean the legume sheller, by carrying trash to a trash bag retainer at the inlet end of the legume sheller.

The legume sheller is operated by beating the legumes in the body of the legume sheller with beaters to remove the legumes from their shells, which form the chaff or trash. The legumes and trash are passed across a screen through which a stream of air passes and blown upwardly into the separator via the air stream, wherein lighter trash passes to a trash retainer and heavier trash and legumes pass over the weir. The heavier trash and legumes pass from the weir to the sieve, wherein the dimension of the throughholes of the sieve is adjusted by sliding the sieve plates relative to one another. The heavier trash passes across the sieve, which is optionally vibrated, wherein the trash and legumes are impeded slightly by the baffles thereon, and wherein the legumes pass through the throughholes, thereby separating the trash from the legumes.

More specifically, the present invention is a legume sheller comprising a body with a cover, an inlet end, an outlet end and a conveyor. The body comprises front legs, rear legs and a blower, wherein the rear legs comprise an air chamber, and wherein the blower is in fluid communication with the air chamber, and wherein the blower forces air into the air chamber, thereby pressurizing same. The outlet end comprises a channel, a screen, a sieve, a vibrator, a collector and a separator, wherein the separator is secured to the outlet end via a hinge, thereby permitting the separator to be moved to facilitate cleaning and/or maintenance. The channel is in fluid communication with the air chamber, wherein air, driven by pressure in the air chamber passes via the channel through the screen into the separator.

The separator has an upper channel, a trash retainer, an inner wall, an outer wall, and a weir, wherein the weir is disposed at a selected dimension and angle between the inner wall and the outer wall. The separator is disposed at the outlet end above the sieve and the screen, wherein the inner wall of the separator is disposed between the screen and the sieve, blocking transit therebetween, and wherein the screen is of a mesh size selected to permit flow of air therethrough, but to reject passage of legumes therethrough. A collector is disposed below the sieve, wherein legumes that pass through the sieve are retained in the collector for subsequent removal. A vibrator selectively provides vibration to increase movement of legumes and/or trash down the sloping surface of the sieve, thereby enabling the trash to pass across the sieve, while the legumes fall into throughholes, passing therethrough into the collector.

The body of the legume sheller comprises an interior cavity, with beaters therewithin and doors, wherein the beaters are rotated by any means such as is known in the art. The doors are removable and comprise alternating long baffles and short baffles, and further comprise slots, wherein the legumes pass through tortuous openings in the doors, passing out of the drum via the slots, while the chaff or trash is rejected and remains on the inside of the doors. Alternation of the long baffles and the short baffles facilitates the entry of the legumes without restriction.

A bag frame is disposed on supports near the front legs, wherein a trash bag is secured to the bag frame via any suitable means such as tying, clipping, folding and/or taping.

The sieve comprises a plate with throughholes therein, wherein the throughholes are selected to a dimension to facilitate passage therethrough of the type of legumes being processed. The plate preferably comprises a first plate section and a second plate section, wherein the first plate section and the second plate section each comprise apertures. The first plate section and the second plate section are slidably disposed against each other, wherein apertures in the plate sections form the throughholes, and wherein the throughholes are selectively enlarged or shrunk by sliding the first section and the second section relative to one another, thereby changing the dimension of the throughholes.

The plate further comprises a front, a rear and baffle plates, wherein the baffler plates are disposed beneath the separator, and wherein the front is disposed proximate the screen.

In use, the legumes are loaded through the input end, wherein the legumes enter the drum. The beaters and the drum are rotated, wherein the beaters impact the legumes in their shells, and wherein the shells are broken and fall apart from the legumes, thereby forming the chaff or trash. The legumes and the trash pass to the inside of the doors, wherein the legumes enter the tortuous openings, passing therethrough, while the trash and legumes that are still in their shells remain within the drum.

The legumes, separated from their shells, and any residual trash, pass from the drum and fall onto the conveyor, wherein the legumes and/or the trash are carried by the conveyor to the outlet end. The legumes and/or the trash pass over the screen, wherein air from the blower propels the legumes and/or residual trash upward into the separator. The trash, being mostly lighter than the legumes, is carried by the selected airflow upward into the upper channel and ultimately into the trash retainer. It will be recognized that the trash retainer could be open to permit flow of the trash into an external collection mechanism.

The legumes, along with larger pieces of residual trash, being too heavy for the selected airflow to lift them into the upper channel, pass over the weir, falling onto the sieve. The legumes and the trash collectively enter the front of the sieve, wherein the legumes and/or the trash pass across the sieve to the rear. Flow of the legumes and/or trash is impeded by the baffles which are disposed in a staggered configuration to direct flow, thereby slightly impeding the progress of the legumes across the sieve, resulting in an increase in the quantity of legumes that enter the throughholes.

Accordingly, the trash, being typically larger than the throughholes, does not pass therethrough, while the legumes fall via the throughholes into the collector for subsequent removal. As the legumes and the trash progress across the sieve, the legumes become few while the proportion of trash increases. Preferably, substantially all the legumes will pass via the throughholes for collection, while substantially all the trash has either been previously retained in the drum, previously been carried via the air separator to the trash retainer, or progressed across the screen to the rear for disposal.

After completion of processing a batch of legumes, the doors are removed for cleaning. The trash within the drum falls onto the conveyor, wherein the conveyor is subsequently operated in reverse, thereby carrying the trash to the trash bag for disposal. The drum and/or the beaters may selectively be rotated to enable additional trash to fall onto the conveyor.

Thus, by removing trash initially via retention in the drum, with subsequent removal of finer pieces of trash via the separator and larger pieces of residual trash via the sieve, high efficiency of removal of trash from legumes is accomplished.

Accordingly, a feature and advantage of the present invention is its ability to separate chaff from legumes.

Another feature and advantage of the present invention is its ability to be adjusted for different size legumes.

Still another feature and advantage of the present invention is its ability to increase the yield of legumes from each processed batch.

Yet another feature and advantage of the present invention is its ability to combine different separation techniques for more effective product yield.

Yet still another feature and advantage of the present invention is its ability to be easily cleaned.

A further feature and advantage of the present invention is its ability to be retrofitted to existing shelling equipment.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1A is a front perspective view of a legume sheller according to a preferred embodiment of the present invention;

FIG. 1B is a detail front view of an output end of a legume sheller according to a preferred embodiment of the present invention, shown opened;

FIG. 2A is an inside perspective view of a door of a legume sheller according to a preferred embodiment of the present invention;

FIG. 2B is front perspective view of a legume sheller according to a preferred embodiment of the present invention, with door removed to reveal beaters;

FIG. 3 is a front perspective view of a legume sheller according to a preferred embodiment of the present invention, with detail of a cleanout trash receiver component;

FIG. 4A is a top view of a sieve component of a legume sheller according to a preferred embodiment of the present invention;

FIG. 4B is a side perspective view of a sieve component of a legume sheller according to a preferred embodiment of the present invention, showing component plates;

FIG. 4C is a perspective view of a sieve component of a legume sheller according to a preferred embodiment of the present invention;

FIG. 5 is a detail front view with partial cutaway of an output end of a legume sheller according to a preferred embodiment of the present invention, shown in use;

FIG. 6A is a side view of a door component of a legume sheller according to a preferred embodiment of the present invention;

FIG. 6B is an inside view of a door component of a legume sheller according to a preferred embodiment of the present invention, with long and short baffles removed; and

FIG. 6C is a side view of a door component of a legume sheller according to a preferred embodiment of the present invention, showing legumes passing therethrough.

### DETAILED DESCRIPTION OF THE PREFERRED AND SELECTED ALTERNATE EMBODIMENTS OF THE INVENTION

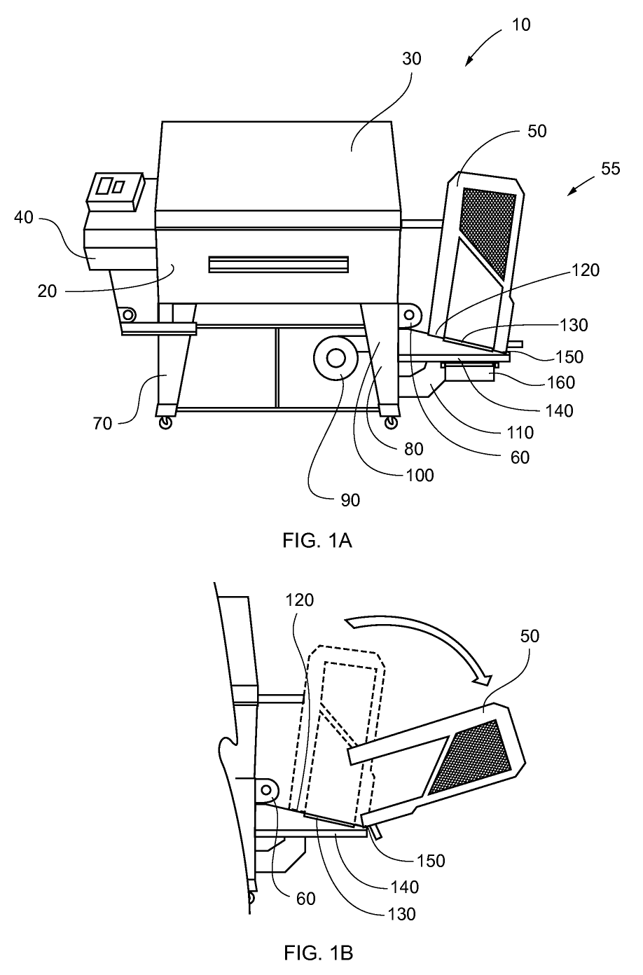

In describing the preferred and selected alternate embodiments of the present invention, as illustrated in FIGS. 1A-6C, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1A-6C, the present invention in a preferred embodiment is legume sheller 10, wherein legume sheller 10 preferably comprises body 20, cover 30, inlet end 40, outlet end 55 and conveyor 60. Body 20 preferably comprises front legs 70, rear legs 80 and blower 90, wherein rear legs 80 preferably comprise air chamber 100, and wherein blower 90 is preferably in fluid communication with air chamber 100, and wherein blower 90 preferably forces air A into air chamber 100, thereby pressurizing same. Outlet end 55 preferably comprises channel 110, screen 120, sieve 130, vibrator 140, collector 160 and separator 50, wherein separator 50 is preferably secured to outlet end 55 via hinge 150, thereby permitting separator 50 to be moved to facilitate cleaning and/or maintenance. Channel 110 is preferably in fluid communication with air chamber 100, wherein air A, preferably driven by pressure in air chamber 100, preferably passes via channel 110 through screen 120 into separator 50. It will be recognized that outlet end 55 could be retrofitted to existing drum shellers by requiring only an airflow source.

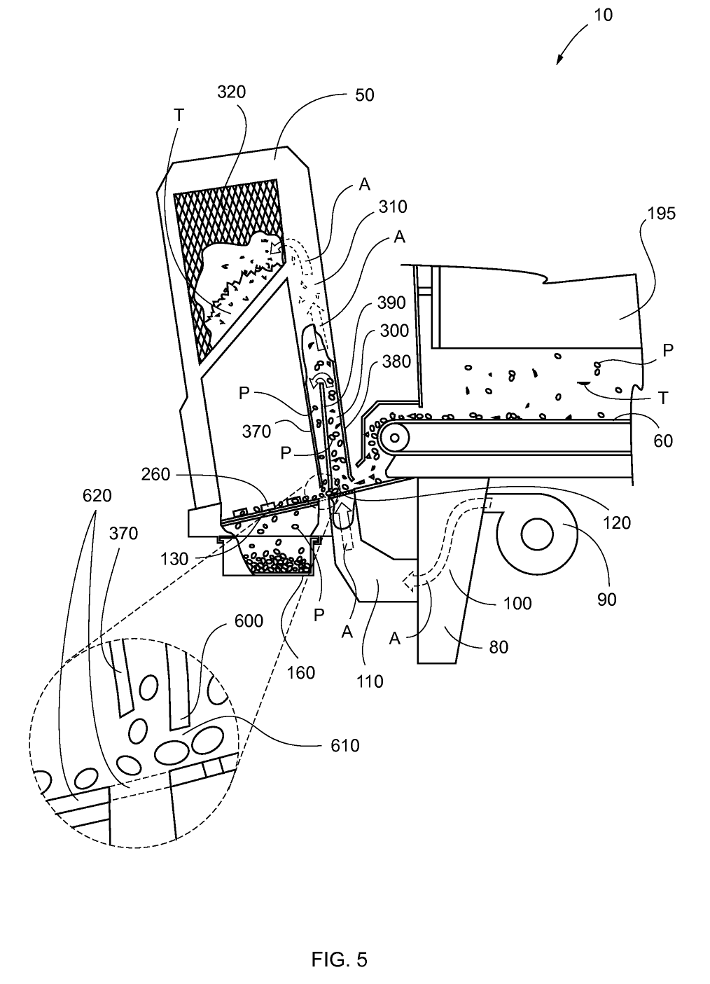

Referring more particularly to FIG. 5, separator 50 preferably comprises upper channel 310, trash retainer 320, inner wall 370, outer wall 380, and weir 390, wherein weir 390 is preferably disposed at a selected dimension and angle between inner wall 370 and outer wall 380. Weir 390 is further disposed above screen 120, wherein tip 600 is separated from screen 120 by gap 610, and wherein gap 610 is dimensioned to permit passage of legumes P therethrough. Bridge 620 provides a travel surface between screen 120 and sieve 130. Upper channel 310 is in communication with trash retainer 320. Separator 50 is preferably disposed at outlet end 55 above sieve 130 and screen 120, wherein inner wall 370 of separator 50 is disposed above bridge 620, between screen 120 and sieve 130, and wherein screen 120 is preferably of a mesh size selected to permit flow of air therethrough but to reject passage of legumes therethrough. Collector 160 is preferably disposed below sieve 130, wherein legumes P that pass through sieve 130 are preferably retained in collector 160 for subsequent removal. Vibrator 140 (best shown in FIG. 1A) preferably selectively provides vibration to increase movement of legumes P and/or trash T down sloping surface of sieve 130, thereby enabling trash T to pass across sieve 130, while legumes P preferably fall into throughholes 275, preferably passing therethrough into collector 160.

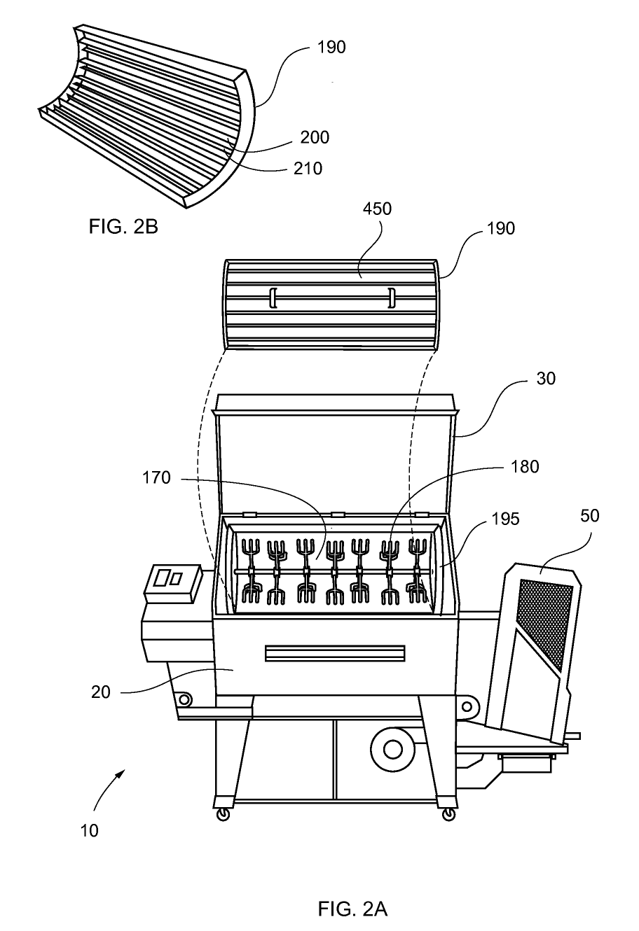

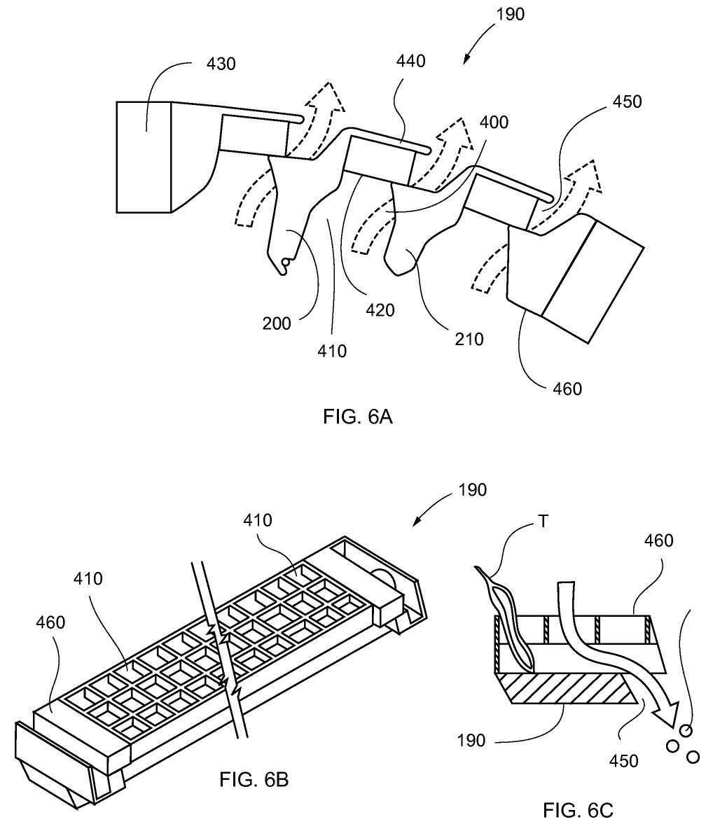

Turning now more particularly to FIGS. 2A-2B and 6A-6C, body 20 of legume sheller 10 preferably comprises interior cavity 170, beaters 180 and doors 190, wherein beaters 180 are preferably disposed within interior cavity 170, and wherein beaters 180 are preferably driven by any means known in the art. Doors 190 are preferably removable and comprise long baffles 200, short baffles 210 and slots 450, wherein legumes P preferably pass through tortuous openings 410 in the doors 190, preferably passing out of drum 195 via slots 450, while chaff or trash T is preferably rejected and remains on inside 460 of doors 190 (best shown in FIG. 6C). Alternation of long baffles 200 and short baffles 210 facilitates the entry of legumes P without restriction.

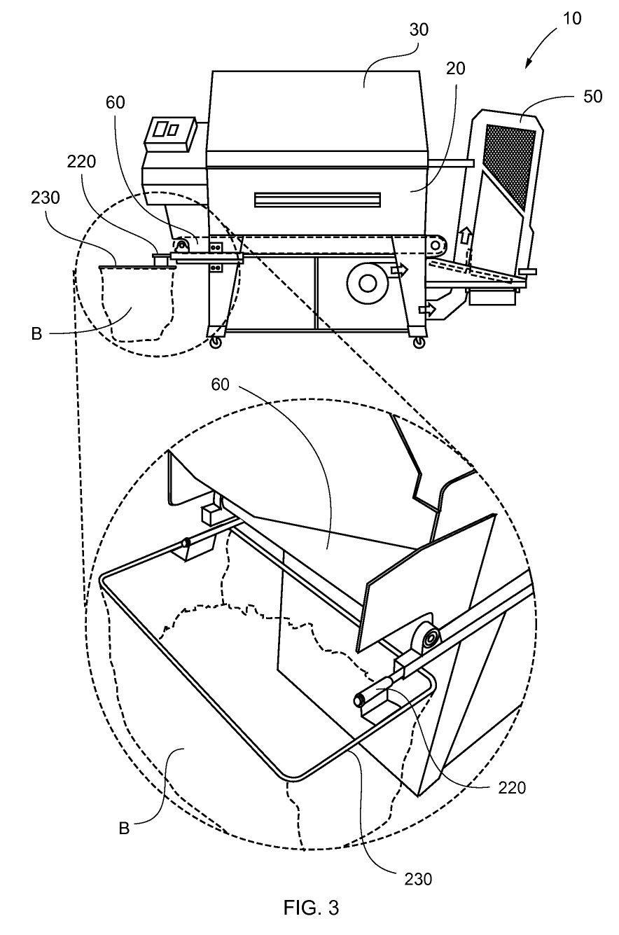

Referring now to FIG. 3, bag frame 230 is preferably disposed on supports 220 proximate front legs 70, wherein trash bag B is preferably secured to bag frame 230 via any suitable means such as tying, clipping, folding and/or taping.

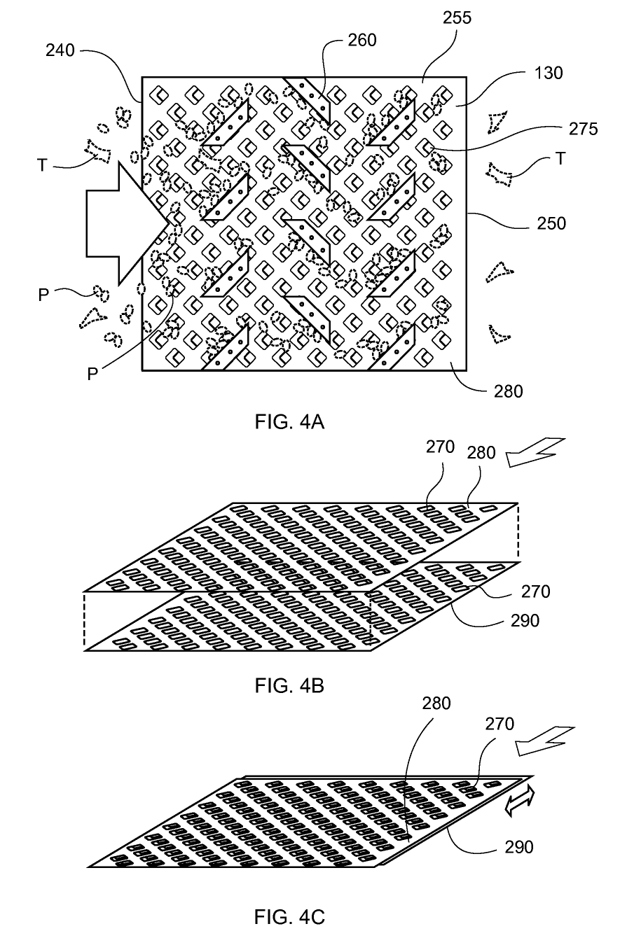

Referring now more particularly to FIGS. 4A-4C, sieve 130 preferably comprises plate 255 with throughholes 275 therein, wherein throughholes 275 are preferably selected to a dimension to facilitate passage of legumes P therethrough. Plate 255 preferably comprises first plate section 280 and second plate section 290, wherein first plate section 280 and second plate section 290 each preferably comprise apertures 270. First plate section 280 and second plate section 290 are preferably slidably disposed against each other, wherein apertures 270 preferably form throughholes 275, and wherein throughholes 275 are preferably selectively enlarged or shrunk by sliding first plate section 280 and second plate section 290 relative to one another as depicted in FIG. 4C, thereby changing the dimension of throughholes 275.

Plate 255 further preferably comprises front 240, rear 250 and baffle plates 260, wherein plate 255 is preferably disposed beneath separator 50, and wherein front 240 is preferably disposed proximate screen 120.

In use, legumes P are preferably loaded through input end 40, wherein legumes P preferably enter drum 195. Beaters 180 and drum 195 are preferably rotated, beaters 180 preferably impacting legumes P in their shells, wherein the shells are broken and fall apart from legumes P, the shells forming chaff or trash T. Legumes P and trash T preferably pass to inside 460 of doors 190, wherein legumes P preferably enter tortuous openings 410, preferably passing therethrough and exiting doors 190 via slots 450, while trash T preferably remains within drum 195 (best shown in FIGS. 5, 6A-6C).

Legumes P, and any residual trash T, preferably pass from drum 195 and fall onto conveyor 60, wherein legumes P and/or trash T are preferably carried by conveyor 60 to outlet end 55. Legumes P and/or trash T preferably pass over screen 120, wherein air A from blower 90 preferably propels legumes P and/or trash T upward into separator 50. Trash T, being lighter than legumes P, is preferably carried by the selected airflow upward into upper channel 310 and ultimately into trash retainer 320. It will be recognized that trash retainer 320 could be open to permit flow of trash T into an external collection mechanism.

The heaviest legumes P are not displaced by airflow and travel across screen 120 through gap 610 to sieve 130. Medium-sized legumes P, being too heavy for a selected airflow to lift them into upper channel 310, but light enough to be partially carried upward, preferably pass over weir 390, falling onto sieve 130. It will be recognized by those skilled in the art that some residual trash T will likely be carried over weir 390 and also pass onto sieve 130. Legumes P and residual trash T preferably collectively enter front 240 (best shown in FIG. 4A) of sieve 130, wherein legumes P and/or trash T preferably pass across sieve 130 to rear 250. Flow of legumes P and/or trash T is preferably impeded by baffles 260 that slow progress to permit legumes P to enter throughholes 275, wherein baffles 260 are disposed in a staggered configuration to direct flow of legumes P and trash T.

Accordingly, trash T, being typically larger than throughholes 275, preferably does not pass therethrough, while legumes P preferably fall via throughholes 275 into collector 160 for subsequent removal. As legumes P and trash T progress across sieve 130, legumes P preferably become few while the proportion of trash T increases. Preferably, substantially all legumes P will pass via throughholes 275 for collection, while substantially all trash T will be retained in drum 195, will be carried to trash retainer 320, or will progress to rear 250 for disposal.

After completion of processing a batch of legumes P, doors 190 are preferably removed for cleaning. Trash T within drum 195 preferably falls onto conveyor 60, wherein conveyor 60 is preferably subsequently operated in reverse, thereby preferably carrying trash T to trash bag B for disposal. Drum 195 may selectively be rotated to enable additional trash to fall from beaters 180 onto conveyor 60.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A legume sheller comprising:
an air separator.

2. The legume sheller of claim 1, further comprising a sieve, wherein said sieve comprises at least one plate.

3. The legume sheller of claim 2, wherein said sieve comprises two plates with apertures therein, and wherein said two plates are disposed against one another and are slidable.

4. The legume sheller of claim 3, wherein said sieve comprises baffles.

5. The legume sheller of claim 4, further comprising a vibration table.

6. The legume sheller of claim 1, wherein said air separator comprises a weir.

7. A legume shelling apparatus comprising:
an air separator; and
a sieve.

8. The legume shelling apparatus of claim 7, wherein said sieve comprises baffles.

9. The legume shelling apparatus of claim 8, wherein said baffles are in a staggered configuration.

10. The legume shelling apparatus of claim 7, further comprising a conveyor, wherein said conveyor is operated in reverse to clean said legume shelling apparatus.

11. The legume shelling apparatus of claim 7, further comprising a trash bag retainer.

12. The legume shelling apparatus of claim 7, wherein said air separator comprises a weir, and wherein said weir comprises a plate disposed at a selected angle within said air separator, and wherein said plate is slightly off-parallel to the walls of said air separator.

13. A method of shelling legumes, said method comprising the steps of:
obtaining a legume sheller having an air separator and a sieve having throughholes;
beating the legumes in said legume sheller to remove the legumes from their shells, the shells forming trash; and
blowing the legumes and trash upward into said air separator, wherein lighter trash passes to a trash retainer and heavier trash and legumes pass over a weir.

14. The method of claim 13, wherein said sieve comprises throughholes, and wherein said sieve comprises two plates, said method further comprising the step of:
adjusting the dimension of said throughholes by sliding said two plates relative to one another.

15. The method of claim 13, wherein said legume sheller further comprises a conveyor, said method further comprising the steps of:
reversing said conveyor; and
transporting the trash to a trash bag attachment.

16. The method of claim 13, further comprising the step of:
sieving the heavier trash and legumes to separate the trash from the legumes.

17. The method of claim 16, further comprising the step of:
baffling flow of the legumes and the heavier trash across said sieve.

18. The method of claim 13, further comprising the step of:
collecting the legumes in a collection receptacle.

19. The method of claim 13, further comprising the step of:
vibrating said sieve.

20. The method of claim 13, further comprising the steps of:
passing the legumes and trash across a mesh through which a stream of air passes;
blowing the trash and the legumes upwardly into said separator via said stream of air;
carrying the trash into a disposal chamber;
passing the legumes to said sieve;
passing the legumes through said sieve into a collection drawer; and
passing residual trash across said sieve for disposal.
